(19) United States
(12) Patent Application Publication
(10) Pub. No.: US 2015/0304195 A1
(43) Pub. Date: Oct. 22, 2015

(54) PLATFORM-ENFORCED USER ACCOUNTABILITY

(71) Applicant: INTEL CORPORATION, Santa Clara,, CA (US)

(72) Inventors: Abhilasha Bhargav-Spantzel, Santa Clara, CA (US); Craig Owen, Folsom, CA (US); Sherry Chang, El Dorado Hills, CA (US); Hormuzd M. Khosravi, Portland, OR (US); Jason Martin, Beaverton, OR (US)

(21) Appl. No.: 14/129,512

(22) PCT Filed: Oct. 10, 2013
(86) PCT No.: PCT/US2013/064376

§ 371 Date: Dec. 26, 2013

(51) Int. Cl. H04L 12/26

(52) U.S. Cl. CPC H04L 43/0876; H04L 43/10

(57) ABSTRACT

Embodiments for implementing platform-enforced user accountability are generally described herein. A policy is accessed at a computing platform, the policy to define an expected behavior of a user of the system. Based on the policy, a sensor to use to enforce the policy is determined Data is obtained from the sensor, with the data indicative of an activity performed by the user, and using the data, a determination is made whether the user is in compliance with the expected behavior defined in the policy.

### TECHNICAL FIELD

Embodiments described herein generally relate to computer monitoring and in particular, to platform-enforced user accountability.

### BACKGROUND

Certain computer-related activities require supervision or user accountability. Monitoring users is a complex problem made even more complex as computer use and the user base grow. Because of the number, the dispersion, or the types of users, it is difficult to allocate appropriate resources, equipment, and personnel to adequately monitor the user base. Practical issues also exist including language and cultural barriers, designing the appropriate type of monitoring, and implementing a system that is accurate and effective. Consequently, assessing and enforcing user actions and behavior on computing platforms is a challenging problem.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a schematic drawing illustrating a system, according to an embodiment;

FIG. 2 is a listing illustrating an example of a policy, according to an example embodiment;

FIG. 3 is a control flow diagram illustrating a process to monitor and evaluate events, and enforce a policy, according to an embodiment;

FIG. 4 is a flow diagram illustrating a method for platform-enforced user accountability on a computing platform; and

FIG. 5 is a block diagram illustrating an example machine upon which any one or more of the techniques (e.g., methodologies) discussed herein may perform, according to an example embodiment.

### DETAILED DESCRIPTION

Computer use monitoring may be used for a variety of purposes, such as for monitoring computer resources to detect a threat (e.g., virus or other infection), misuse (e.g., illegal activities on the computer), or other misconduct. Computer use monitoring may monitor activities on a computing device or activities occurring in proximity to the computing device. Misuse and misconduct may take several forms and are largely evaluated based on context. For example, workplace misconduct may be characterized by activities that are very dissimilar to activities considered as misconduct at home. As such, the present disclosure describes a policy management platform that allows an authority to create and deploy one or more policies designed for particular contexts. The policies may be implemented at one or more computer platforms. Computer platforms include, but are not limited to a laptop machine, a desktop machine, a mobile device (e.g., cell phone, notebook, netbook, tablet, Ultrabook™, or hybrid device), a kiosk, or a wearable device.

In some cases, computer use monitoring may be performed by proctors, teachers, parents, civil servants, or other people of authority. For example, when taking a test on a computing device at a remote location, to ensure the integrity of the testing environment, a proctor may monitor the test taker or the environment, such as with a video camera.

In other cases, computer use monitoring may be performed by automated or semi-automated processes, such as by software installed on the computing device being used for testing. Software may prohibit certain functions from being performed, monitor and track user activity, log user activity, or administer policies at the computing device.

Computer activities—both online and offline—continue to grow in leaps and bounds. As computer activities increase, so does the need to monitor such activities to ensure that the user is complying with approved behavior. Monitoring may be used in various contexts, such as at home, at work, or for online assessments. Some mechanisms exist for accountability regarding Internet usage, such as with filtering, blocking peripheral devices, and the like, but such solutions are limited. They do not provide enough fine-grained control and may be easy to defeat. Other mechanisms, such as using remote proctors, do not easily scale to the number of potential users.

The present disclosure describes a hardware-based mechanism to assess user actions and ensure that such actions are consistent with a policy defined by an authority. In some examples, the monitoring is continuous.

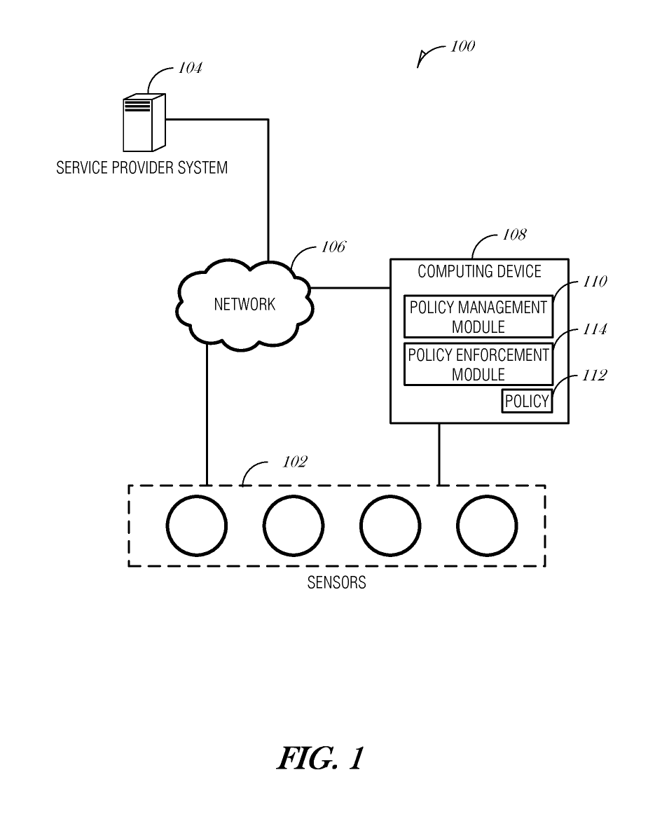

FIG. 1 is a schematic drawing illustrating a system 100, according to an embodiment. The system 100 includes one or more sensors 102 and a service provider system 104, which are connected over a network 106. While the service provider system 104 is illustrated as a single machine in FIG. 1, in various embodiments, the service provider system 104 may comprise multiple servers working together (e.g., colocated, distributed, or as a cloud-based system). Additionally, a computing device 108 is connected to the service provider system 104 via the network 106.

The sensors 102 includes devices such as a camera, microphone, keyboard, mouse, input device (e.g., a light pen), biometric reader (e.g., fingerprint or retina scanner), accelerometer, physiological sensor (e.g., heart rate monitor, blood pressure monitor, skin temperature monitor, or the like), proximity detector (e.g., motion detector or heat sensor), or other sensing device. The sensors 102 may be connected to the service provider system 104 via the network 106 substantially directly, or may be solely connected to the computing device 108, or connected to both the computing device 108 and the network 106. The sensors 102 may provide data to the computing device 108 directly, such as by way of a wired or wireless connection, or indirectly, such as by way of the network 106. The sensors 102 may be arranged to transmit and receive wireless signals using various technologies. Examples of wireless technologies include, but are not limited to Bluetooth™, Wi-Fi®, cellular, radio-frequency identification (RFID), WiMAX®, and the like. The sensors may be incorporated into the computing device 108 (e.g., a camera included in a bezel of a display frame) or be communicatively coupled to the computing device 108 (e.g., with a short-range wireless connection).

As an initial operation, one or more policies are created or modified. The policies may be created on service provider system 104 or the computing device 108. For example, an administrative user may create or modify a policy at the service provider system 104 for use in a particular context (e.g., test taking) on one or more client machines (e.g., computing device 108). After completing the policy, the administrative user may push the policy to one or more client machines. In addition to, or in the alternative, an administrative user may create or modify a policy on a client machine (e.g., computing device 108) for use on the client machine. A locally created policy, such as one created at a client machine, may be pushed or uploaded to a server system (e.g., service provider system 104) for use in one or more other client machines. There may be a certification or other process to check the completeness, authenticity, or validity of a policy uploaded to the service provider system 104 before allowing the policy to be disseminated to other client machines or used on the creation client machine.

A policy may be created or modified based on a template of expected behavior. The definition of the expected behavior may be based on templates. Such templates may be based on simulated or actual behavior data. Using simulated or actual behavior data along with machine learning or other human input, a template may be created that outlines user behavior that should and should not exist during a particular activity or context. In addition to monitored behavior, a machine learning mechanism may be used to determine which sensor(s) may be used to enforce a particular policy. This determination may be performed at the server level (e.g., service provider system 104) or the client level (e.g., computing device 108), or using both client and server in combination.

A policy may include one or more rules. A rule may be composed of two parts: an object and a property. Objects may be things or actions. For example, objects may be “a book,” “a phone,” “a person,” or “a face.” Further examples of objects (as actions) include “browsing the internet,” “looking at book,” or “using phone.”

Properties are used to define permissions with respect to the object. Examples of properties include “must not exist,” “must exist,” “cannot look,” “should look,” etc. As can be seen, the mere presence of an object (e.g., a book) may be in violation of a rule or the use of the object (e.g., looking at the book) may be in violation of a rule. Objects and properties may be conveyed in a standardized language, such as extensible markup language (XML), or some specific schema using a standardized language.

A policy may also include other directives, such as an authentication directive or a remedial action directive. An authentication directive may be used to indicate to the client machine (e.g., computing device 108) that the user should be authenticated before enforcing the policy. A remedial action directive may be used to specify one or more remedial actions to perform when a violation of the policy is detected.

In an embodiment, the computing device 108 includes a policy management module 110 to access a policy 112, the policy to define an expected behavior of a user of the system and a policy enforcement module 114. The policy enforcement module can be used to determine, based on the policy, a sensor to use to enforce the policy. Then the policy enforcement module can obtain data from the sensor, the data indicative of an activity performed by the user and use the data to determine whether the user is in compliance with the expected behavior defined in the policy 112.

In an embodiment, the policy enforcement module 114 uses artificial intelligence to determine the sensor to use to enforce the policy. In a further embodiment, the policy enforcement module 114 uses a neural network as a portion of the artificial intelligence.

The policy 112 can be stored in a structured language format. In an embodiment, the structured language format comprises an extensible markup language (XML).

In an embodiment, the policy management module 110 accesses the policy by receiving the policy from a policy server (e.g., service provider system 104) remote from the computing device 108. In an embodiment, the policy management module 110 receives the policy 112 from the policy server as a portion of a power on sequence of the computing device 108.

In an embodiment, the policy management module 110 provides an interface to a policy administrator to create or modify the policy at the computing device. In an embodiment, the policy management module 110 pushes the policy 112 to a policy server, the policy server being remote from the computing device 108.

In an embodiment, the policy enforcement module 114 logs information regarding the activity performed by the user when the user is not in compliance with the expected behavior defined in the policy 112.

In an embodiment, the policy enforcement module 114 transmits an alert to a policy server (e.g., service provider system 104) when the user is not in compliance with the expected behavior defined in the policy 112, the alert including information regarding the activity performed by the user, and the policy server being remote from the computing device 108. In an embodiment, the policy enforcement module 114 initiates a remedial procedure when the activity performed by the user indicates that the user is not in compliance with the expected behavior defined in the policy 112. In an embodiment, the remedial procedure is at least one of: interrupting an application the user is using on the apparatus, providing an alert to the user, or transmitting a recording of the activity performed by the user to the policy server.

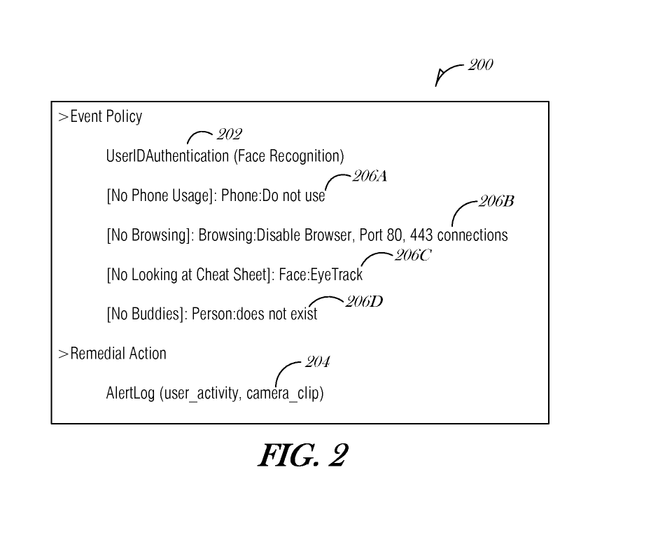

FIG. 2 is a listing illustrating an example of a policy 200, according to an example embodiment. The policy 200 includes an authentication directive 202 and a remedial directive 204. The authentication directive 202 commands that the computing device 108 perform facial recognition on the user before enforcing the policy or allowing the user to perform the activity. For example, before a testing application is initiated on the computing device 108, the user may have to authenticate themselves to the computing device 108 in order to access a test provided by the testing application. The remedial directive 204 indicates that a description of the user activity performed that violated a rule should be recorded with the video or photographic evidence related to the rule violation. This data may be used to audit the system, enforce rules after an incident has occurred, or as input into machine learning algorithms.

In addition, the policy 200 includes four rules 206A-D. Each rule 206 is provided in a format of: [rule description]: object:property. For example, rule 206A refers to phone usage and indicates that phones are not to be used. Video analysis, object tracking, and artificial intelligence may be used to monitor a user at the computing device 108 and determine whether the user picks up a phone or otherwise activates a phone in the user's proximity. Rule 206B refers to browsing behavior and disables browsing client(s) on the computing device 108 along with certain ports. Rule 206C refers to using a cheat sheet or other notes. By tracking the user's face (e.g., with video or photo analysis) and the user's eyes, the computing device 108 may be able to determine whether the user is predominately looking at the screen or away from the screen. Such activities may be cross-referenced with video or photographic data to determine whether other objects are proximate to the user that may constitute notes or a cheat sheet.

In some cases, the user may look to the ceiling to think (e.g., when considering the answer to a test question). This eye motion should not be flagged as inappropriate. Using camera data may avoid a false positive assertion. Rule 206D refers to a rule that no one else should be in the room or at the computer while the user is performing the activity. Using object tracking, video analysis, sound analysis, motion detection, or other mechanisms, the computing device 108 may determine whether another person is proximate to the user or otherwise assisting the user.

After a policy is prepared, it is disseminated to one or more clients (e.g., computing device 108). In operation, a user may operate the computing device 108 to perform some activity. The computing device 108 may be any type of device including a desktop computer, smartphone, cellular telephone, mobile phone, laptop computer, tablet computer, Ultrabook™, in-vehicle computer, kiosk, or other networked device. The activity may be any type of activity, but is usually one that requires some form of proctoring or moderating. Example activities include, but are not limited to test taking, online course work, remote work, homework, and the like. At some point in time, the computing device 108 may access and load the policy. In an example, the policy is loaded when the computing device 108 is powering up (e.g., as part of a startup routine). The policy may be loaded with the operating system or may be loaded as part of a basic input/output system (BIOS) operation.

Based on the policy, the computing device 108 chooses a set of one or more sensors to use for monitoring user activity in accordance with the policy. The goal of monitoring is to ensure that the user is not acting in violation of rules defined in the policy. As the computing device 108 monitors the user activity, a machine learning mechanism may be used to determine the best mechanism to enforce the policy. The machine learning may be based on previous monitoring periods of the current user or other monitoring data from other users.

When the user's actions deviate from the expected behavior, then an alert may be triggered. Enforcement of the user's actions may be performed at run time, such as by disabling an application, logging an alert, or revoking user rights on the computing device 108. In addition to, or in the alternative to run time enforcement, post-incident enforcement may be used. For example, if the policy was used to proctor an online exam, then exam results may be invalided if the behavior was outside of the expected behavior. In a post-incident enforcement scenario, a human review process may be used to double check the user's behavior and other data before issuing any penalties (e.g., test invalidation).

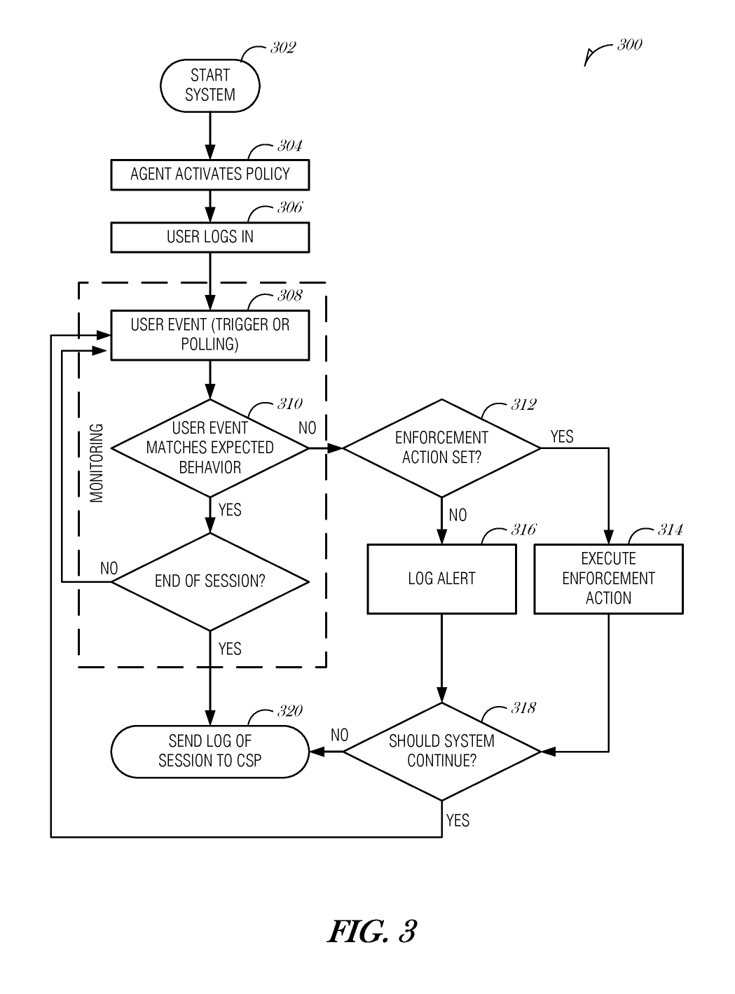

FIG. 3 is a control flow diagram illustrating a process 300 to monitor and evaluate events, and enforce a policy, according to an embodiment. At block 302, the system is started up. For example, the computing device 108 is powered on. At block 304, an agent activates a policy. The policy may be for a particular task or for general computer/user monitoring. At block 306, the user logs into the system. After the user logs in, continuous monitoring of the user's activities is conducted. A user event is detected at block 308. User events may be detected by a triggering mechanism or a polling mechanism.

A triggering mechanism works by monitoring and detecting a condition or event. For example, one or more sensors may be used to monitor ambient noise. When the ambient noise rises above a certain threshold, which may indicate someone talking or whispering answers to a test question, a triggering mechanism may raise an alert.

A polling mechanism works by intermittently sampling data from one or more sensors and then evaluating the data to determine whether an exception condition exists. A polling mechanism with a very short polling period (e.g., 0.5 seconds) may act substantially similar to a triggering mechanism. Longer polling periods may be used, such as two seconds, five seconds, or a minute. For example, one or more cameras may be used to periodically obtain a picture of a testing environment every thirty seconds. Analyzing the picture may reveal an unauthorized person at the testing environment.

The detected user event is compared to the expected behavior defined in the policy (block 310), then if the user event does abide by the policy, monitoring continues in the loop until an end of session signal occurs (e.g., a logout or shutdown command). If the user event does not abide by the policy, at decision block 312, the method 300 determines whether an enforcement action is set. Enforcement actions may include passive actions, such as logging, or more active or intrusive actions, such as interrupting the user's work or shutting down the system. If an enforcement policy is set, then at block 314, the enforcement action is executed. If an enforcement policy is not set, then at block 316, an alert is logged. In some examples, when the enforcement action is executed, a log of the enforcement action is maintained. At decision block 318, it is determined whether the system should continue. If the determination is positive, then the method 300 continues at block 308, monitoring for additional user events. Otherwise, the method 300 proceeds to block 320, where a log of the session is sent to a cloud service provider (CSP).

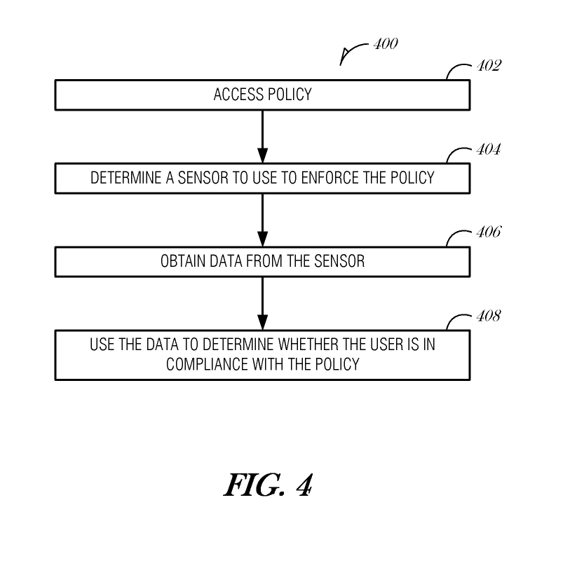

FIG. 4 is a flow diagram illustrating a method 400 for platform-enforced user accountability on a computing platform, according to an embodiment. At block 402, a policy is accessed. The policy may be configured to define an expected behavior of a user of the system. In an embodiment, the policy is stored in a structured language format. In a further embodiment, the structured language format comprises an extensible markup language (XML).

In an embodiment, accessing the policy comprises receiving the policy from a policy server remote from the computing platform. The policy may be retrieved from the remote policy server at certain times during a computer's use, such as during startup or power on. Thus, in an embodiment, receiving the policy comprises receiving the policy from the policy server as a portion of a power on sequence of the computing platform.

At block 404, based on the policy, a sensor to use to enforce the policy is determined In an embodiment, determining the sensor comprises using artificial intelligence to determine the sensor to use to enforce the policy. In a further embodiment, using artificial intelligence comprises using a neural network as a portion of the artificial intelligence. In other embodiments, logic programming, automated reasoning, Bayesian networks, decision theory, or statistical learning methods may be used. For example, if a policy restriction is to limit the number of people in a room to one (e.g., a test taker), the a microphone and a camera (or camera array) may be enabled to determine certain ambient noise levels, multiple voice patterns, or multiple people in a picture/video, any of which may indicate a policy violation.

In various embodiments, the sensor is one of: a camera, a microphone, or a keyboard. Other sensors may be implemented, such as a motion detector, thermal imager, humidity sensor, vibration sensor, or a photodetector. In an embodiment, the sensor is incorporated into the computing platform.

At block 406, data is obtained from the sensor, where the data is indicative of an activity performed by the user.

At block 408, the data is used to determine whether the user is in compliance with the expected behavior defined in the policy at the computing platform.

In some embodiments, a user interface is provided to a local user of the computing platform (e.g. a local proctor) to create or modify a policy at the computing platform. Thus, in an embodiment, the method 400 comprises providing an interface to a policy administrator to create or modify the policy at the computing platform. After finalizing the policy, the policy may be published to the remote server. Thus, in an embodiment, the method 400 includes pushing the policy to a policy server, the policy server being remote from the computing platform.

In some embodiments, the user activity is logged. Thus, in an embodiment, the method 400 includes logging information regarding the user activity when the user is not in compliance with the expected behavior defined in the policy.

In some embodiments, the user activity is logged and a log of the user activity is transmitted to a remote server (e.g. policy server) to store or analyze. Thus, in an embodiment, the method 400 includes transmitting an alert to a policy server when the user is not in compliance with the expected behavior defined in the policy, the alert including information regarding the user activity, and the policy server being remote from the computing platform.

In some embodiments, policy enforcement includes implementing a remedial process. Thus, in an embodiment, the method 400 includes initiating a remedial procedure when the user activity indicates that the user is not in compliance with the expected behavior defined in the policy. In various embodiments, the remedial procedure is at least one of: interrupting an application the user is using on the computing platform, providing an alert to the user, or transmitting a recording of the user activity to the policy server.

### Hardware Platform

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

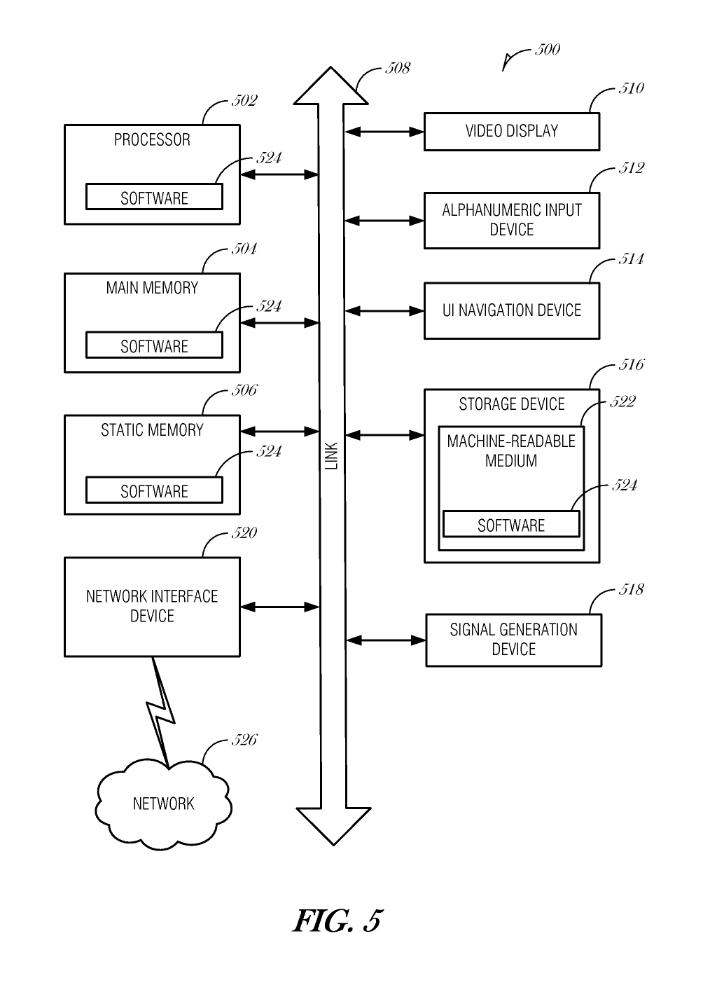

FIG. 5 is a block diagram illustrating a machine in the example form of a computer system 500, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a personal computer (PC), a tablet PC, a set-top box (STB), a personal digital assistant (PDA), a mobile telephone, a web appliance, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 500 includes at least one processor 502 (e.g., a central processing unit (CPU), a graphics processing unit (GPU) or both, processor cores, compute nodes, etc.), a main memory 504 and a static memory 506, which communicate with each other via a link 508 (e.g., bus). The computer system 500 may include combinations of links and busses. The computer system 500 may further include a video display unit 510, an alphanumeric input device 512 (e.g., a keyboard), and a user interface (UI) navigation device 514 (e.g., a mouse). In one embodiment, the video display unit 510, input device 512 and UI navigation device 514 are incorporated into a touch screen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, or other sensor.

The storage device 516 includes a machine-readable medium 522 on which is stored one or more sets of data structures and instructions 524 (e.g., software) embodying or utilized by any one or more of the methodologies or functions described herein. The instructions 524 may also reside, completely or at least partially, within the main memory 504, static memory 506, and/or within the processor 502 during execution thereof by the computer system 500, with the main memory 504, static memory 506, and the processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the one or more instructions 524. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 524 may further be transmitted or received over a communications network 526 using a transmission medium via the network interface device 1020 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples:

Example 1 includes subject matter for platform-enforced user accountability (such as a device, apparatus, or machine) comprising a policy management module to access a policy, the policy to define an expected behavior of a user of the system; and a policy enforcement module to: determine, based on the policy, a sensor to use to enforce the policy; obtain data from the sensor, the data indicative of an activity performed by the user; and use the data to determine whether the user is in compliance with the expected behavior defined in the policy.

In Example 2, the subject matter of Example 1 may optionally include, wherein the policy enforcement module is to use artificial intelligence to determine the sensor to use to enforce the policy.

In Example 3 the subject matter of any one or more of Examples 1 to 2 may optionally include, wherein the policy enforcement module is to use a neural network as a portion of the artificial intelligence.

In Example 4 the subject matter of any one or more or more of Examples 1 to 3 may optionally include, wherein the sensor is one of: a camera, a microphone, or a keyboard.

In Example 5 the subject matter of any one or more of Examples 1 to 4 may optionally include, wherein the sensor is incorporated into the apparatus.

In Example 6 the subject matter of any one or more of Examples 1 to 5 may optionally include, wherein the policy is stored in a structured language format.

In Example 7 the subject matter of any one or more of Examples 1 to 6 may optionally include, wherein the structured language format comprises an extensible markup language.

In Example 8 the subject matter of any one or more of Examples 1 to 7 may optionally include, wherein the policy management module is to access the policy by receiving the policy from a policy server remote from the apparatus.

In Example 9 the subject matter of any one or more of Examples 1 to 8 may optionally include, wherein the policy management module is to receive the policy from the policy server as a portion of a power on sequence of the apparatus.

In Example 10 the subject matter of any one or more of Examples 1 to 9 may optionally include, wherein the policy management module is to provide an interface to a policy administrator to create or modify the policy at the apparatus.

In Example 11 the subject matter of any one or more of Examples 1 to 10 may optionally include, wherein the policy management module is to push the policy to a policy server, the policy server being remote from the apparatus.

In Example 12 the subject matter of any one or more of Examples 1 to 11 may optionally include, wherein the policy enforcement module is to log information regarding the activity performed by the user when the user is not in compliance with the expected behavior defined in the policy.

In Example 13 the subject matter of any one or more of Examples 1 to 12 may optionally include, wherein the policy enforcement module is to transmit an alert to a policy server when the user is not in compliance with the expected behavior defined in the policy, the alert including information regarding the activity performed by the user, and the policy server being remote from the apparatus.

In Example 14 the subject matter of any one or more of Examples 1 to 13 may optionally include, wherein the policy enforcement module is to initiate a remedial procedure when the activity performed by the user indicates that the user is not in compliance with the expected behavior defined in the policy.

In Example 15 the subject matter of any one or more of Examples 1 to 14 may optionally include, wherein the remedial procedure is at least one of: interrupting an application the user is using on the apparatus, providing an alert to the user, or transmitting a recording of the activity performed by the user to the policy server.

Example 16 includes subject matter for platform-enforced user accountability (such as a method, means for performing acts, machine readable medium including instructions that when performed by a machine cause the machine to performs acts, or an apparatus configured to perform) comprising accessing a policy at a computing platform, the policy to define an expected behavior of a user of the system; determining at the computing platform, based on the policy, a sensor to use to enforce the policy; obtaining data from the sensor, the data indicative of an activity performed by the user; and using the data to determine whether the user is in compliance with the expected behavior defined in the policy at the computing platform.

In Example 17, the subject matter of Example 16 may optionally include, wherein determining the sensor comprises using artificial intelligence to determine the sensor to use to enforce the policy.

In Example 18 the subject matter of any one or more of Examples 16 to 17 may optionally include, wherein using artificial intelligence comprises using a neural network as a portion of the artificial intelligence.

In Example 19 the subject matter of any one or more of Examples 16 to 18 may optionally include, wherein the sensor is one of: a camera, a microphone, or a keyboard.

In Example 20 the subject matter of any one or more of Examples 16 to 19 may optionally include, wherein the sensor is incorporated into the computing platform.

In Example 21 the subject matter of any one or more of Examples 16 to 20 may optionally include, wherein the policy is stored in a structured language format.

In Example 22 the subject matter of any one or more of Examples 16 to 21 may optionally include, wherein the structured language format comprises an extensible markup language.

In Example 23 the subject matter of any one or more of Examples 16 to 22 may optionally include, wherein accessing the policy comprises receiving the policy from a policy server remote from the computing platform.

In Example 24 the subject matter of any one or more of Examples 16 to 23 may optionally include, wherein receiving the policy comprises receiving the policy from the policy server as a portion of a power on sequence of the computing platform.

In Example 25 the subject matter of any one or more of Examples 16 to 24 may optionally include, providing an interface to a policy administrator to create or modify the policy at the computing platform.

In Example 26 the subject matter of any one or more of Examples 16 to 25 may optionally include, pushing the policy to a policy server, the policy server being remote from the computing platform.

In Example 27 the subject matter of any one or more of Examples 16 to 26 may optionally include, logging information regarding the activity performed by the user when the user is not in compliance with the expected behavior defined in the policy.

In Example 28 the subject matter of any one or more of Examples 16 to 27 may optionally include, comprising transmitting an alert to a policy server when the user is not in compliance with the expected behavior defined in the policy, the alert including information regarding the activity performed by the user, and the policy server being remote from the computing platform.

In Example 29 the subject matter of any one or more of Examples 16 to 28 may optionally include, initiating a remedial procedure when the activity performed by the user indicates that the user is not in compliance with the expected behavior defined in the policy.

In Example 30 the subject matter of any one or more of Examples 16 to 29 may optionally include, wherein the remedial procedure is at least one of: interrupting an application the user is using on the computing platform, providing an alert to the user, or transmitting a recording of the activity performed by the user to the policy server.

Example 31 includes a machine-readable medium including instructions that when performed by a machine cause the machine to perform any one of the examples of 1-30.

Example 32 includes subject matter for platform-enforced user accountability comprising means for performing any one of the examples of 1-30.

Example 33 includes an apparatus for platform-enforced user accountability, the apparatus comprising: means for accessing a policy at a computing platform, the policy to define an expected behavior of a user of the system; means for determining at the computing platform, based on the policy, a sensor to use to enforce the policy; means for obtaining data from the sensor, the data indicative of an activity performed by the user; and means for using the data to determine whether the user is in compliance with the expected behavior defined in the policy at the computing platform.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. §1.72(b) in the United States of America. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1-25. (canceled)

26. An apparatus for platform-enforced user accountability, the apparatus comprising:
a policy management module to access a policy, the policy to define an expected behavior of a user of the system; and
a policy enforcement module to:
determine, based on the policy, a sensor to use to enforce the policy;
obtain data from the sensor, the data indicative of an activity performed by the user; and
use the data to determine whether the user is in compliance with the expected behavior defined in the policy.

27. The apparatus of claim 26, wherein the policy enforcement module is to use artificial intelligence to determine the sensor to use to enforce the policy.

28. The apparatus of claim 27, wherein the policy enforcement module is to use a neural network as a portion of the artificial intelligence.

29. The apparatus of claim 26, wherein the sensor is one of: a camera, a microphone, or a keyboard.

30. The apparatus of claim 29, wherein the sensor is incorporated into the apparatus.

31. The apparatus of claim 26, wherein the policy is stored in a structured language format.

32. The apparatus of claim 31, wherein the structured language format comprises an extensible markup language.

33. The apparatus of claim 26, wherein the policy management module is to access the policy by receiving the policy from a policy server remote from the apparatus.

34. The apparatus of claim 33, wherein the policy management module is to receive the policy from the policy server as a portion of a power on sequence of the apparatus.

35. The apparatus of claim 26, wherein the policy management module is to provide an interface to a policy administrator to create or modify the policy at the apparatus.

36. The apparatus of claim 35, wherein the policy management module is to push the policy to a policy server, the policy server being remote from the apparatus.

37. The apparatus of claim 36, wherein the policy enforcement module is to log information regarding the activity performed by the user when the user is not in compliance with the expected behavior defined in the policy.

38. The apparatus of claim 36, wherein the policy enforcement module is to transmit an alert to a policy server when the user is not in compliance with the expected behavior defined in the policy, the alert including information regarding the activity performed by the user, and the policy server being remote from the apparatus.

39. The apparatus of claim 38, wherein the policy enforcement module is to initiate a remedial procedure when the activity performed by the user indicates that the user is not in compliance with the expected behavior defined in the policy.

40. The apparatus of claim 39, wherein the remedial procedure is at least one of: interrupting an application the user is using on the apparatus, providing an alert to the user, or transmitting a recording of the activity performed by the user to the policy server.

41. A method for platform-enforced user accountability, the method comprising:
accessing a policy at a computing platform, the policy to define an expected behavior of a user of the system;
determining at the computing platform, based on the policy, a sensor to use to enforce the policy;
obtaining data from the sensor, the data indicative of an activity performed by the user; and
using the data to determine whether the user is in compliance with the expected behavior defined in the policy at the computing platform.

42. The method of claim 41, wherein determining the sensor comprises using artificial intelligence to determine the sensor to use to enforce the policy.

43. The method of claim 42, wherein using artificial intelligence comprises using a neural network as a portion of the artificial intelligence.

44. The method of claim 41, wherein the policy is stored in a structured language format, wherein the structured language format comprises an extensible markup language.

45. A machine-readable medium including instructions for platform-enforced user accountability, which when executed by a machine, cause the machine to:
access a policy at a computing platform, the policy to define an expected behavior of a user of the system;
determine at the computing platform, based on the policy, a sensor to use to enforce the policy;
obtain data from the sensor, the data indicative of an activity performed by the user; and
use the data to determine whether the user is in compliance with the expected behavior defined in the policy at the computing platform.
